(19) United States
(12) Patent Application Publication
(10) Pub. No.: US 2011/0153484 A1
(43) Pub. Date: Jun. 23, 2011

(54) SYSTEMS AND METHODS FOR CENTRAL PROCESSING OF MUTUAL FUND TRANSACTIONS

(75) Inventors: Charles A. BAKER, Wayne, PA (US); Lisa Dallmer, New York, NY (US)

(73) Assignee: NYSC Group, Inc., New York, NY (US)

(21) Appl. No.: 12/971,401

(22) Filed: Dec. 17, 2010

Related U.S. Application Data
(60) Provisional application No. 61/287,674, filed on Dec. 17, 2009.

(51) Int. Cl. G06Q 40/00

(52) U.S. Cl. 705/37

(57) ABSTRACT

More efficient systems and methods for processing mutual fund transactions are provided by a centralized settlement and record-keeping repository for mutual fund shares. These systems and methods result in significant enhancements and cost savings to the mutual fund industry.

### PRIORITY CLAIM

This application benefits from priority to provisional U.S. patent application Ser. No. 61/287,674, filed Dec. 17, 2009.

### BACKGROUND OF THE INVENTION

In equity trading, when an investor buys securities through a brokerage firm, most firms will automatically put the securities held by that investor into “street name.” This means the brokerage firm will hold the securities in its name or another name and not in the investor's name, but the firm will keep records showing the investor as the real or “beneficial owner.” The investor does not get a paper certificate, but receives an account statement from the broker on at least a quarterly and annual basis showing the investor's holdings. More than 75% of all equity shares are held in this “street name” form, meaning that the registered owner is a broker, bank, or other third party financial institution. This practice of registering securities in the name of an institution other than the underlying investor helps to facilitate the processing of securities transactions.

Until the early 1970's, securities ownership was represented with paper certificates. Brokers on Wall Street used runners to exchange stock certificates among financial institutions at the end of each trading day. As the trading of securities became more sophisticated and occurred in greater volumes, Wall Street suffered a paperwork crisis that almost crippled the securities industry in the late 1960's.

Today, securities transactions are settled through centralized securities depositories. Securities are settled in a process in which the securities or interests in securities are delivered to depositories, usually in simultaneous exchange for cash, to fulfill contractual obligations, such as those arising from securities trades. These depositories register and hold the securities in “street” name for financial institutions, such as brokers and banks, which are participants in this system. By holding securities in street name, these depositories are able to facilitate the transfer of securities by computerized book-entry systems, instead of having to physically move stock certificates.

Purchases and sales of mutual fund shares, however, are handled quite differently. Most mutual fund companies continuously offer new shares of their funds to the public and redeem (purchase) shares from investors at a price based on the current value of fund assets plus any sales charges. Mutual fund shares can only be purchased (created) and sold (redeemed) through the issuing fund (that is, mutual fund shareholders may not buy or sell the mutual fund shares from each other as with shares of operating companies). In addition, orders for mutual fund shares may be specified as either a specific number of shares to be purchased or sold, or as a specific amount of cash to be invested in the purchase or generated from the sale of mutual fund shares. This does result in fractional shares being transacted. Investors may purchase (or sell) fund shares with the issuing fund using three basic processes:

(1) Direct purchases from a mutual fund company (“Direct”). Many mutual fund companies accept purchase and redemption orders directly from investors without the involvement of an intermediary. The accounts opened are individual accounts on the records of the fund transfer agent, who is an agent employed by a corporation or mutual fund company to maintain shareholder records, including purchases, sales, and account balances. These accounts are generally known as “retail accounts.” These purchases are processed with the fund company directly, not through an intermediary such as a broker/dealer. The fund is the primary point of contact for the investor and provides all shareholder servicing and recordkeeping.

(2) Direct purchases from a broker/dealer (“B/D Individual”). In this process, individual accounts are opened with the mutual fund company through a broker/dealer, and the mutual fund shares are typically held in the name of the B/D on behalf of its customer (i.e., “street name”). In this case the B/D is the sole point of contact for the investor and provides shareholder servicing and recordkeeping.

(3) Broker/dealer omnibus account (“B/D Omnibus”). The final method for investors to trade and hold mutual fund shares is through a B/D “omnibus” account. An omnibus account is a master account representing subaccounts of multiple investors. An omnibus account is opened on the records of the mutual fund company in the name of the broker/dealer (a form, again, of “street name”). The B/D aggregates trade activity for the subaccounts in the omnibus account and typically sends one trade to the fund transfer agent each day on which there is trading activity for a fund. The one trade typically represents the net of all purchases and redemptions in all of the subaccounts. The fund complex typically does not have any information identifying or otherwise relating to the individual owners of the subaccounts. Thus, the share balance on the books of the fund transfer agent is the aggregate share balance of all the subaccounts of multiple investors in that fund held in the B/D account and the B/D provides the investor all shareholder servicing and recordkeeping.

For example, a B/D may have an omnibus account with two individual investors, both of whom are purchasing 100 shares of the same fund. The total number of shares to be purchased is 200 shares; 100 shares for each individual. The broker/dealer enters the individuals' orders on its system, but sends only a single purchase order for 200 shares of that fund to the mutual fund company.

Over the past 15 years, the distribution model for mutual fund shares has shifted from Direct to B/D Omnibus. This trend results in an increasing shift to “street-side accounting,” wherein shares of the fund are held on behalf of the investor, but in the name of the investor's B/D. While both the mutual fund transaction processes and the equity market processes use “street-side” accounting, neither mutual fund companies nor B/Ds are taking full advantage of the benefits of “street-side” settlement and record-keeping. Trade settlement takes place directly between the fund company and the intermediaries (such as a B/D) or investor who initiated the trade. Any distributions, such as dividend payments or capital gains distributions, from the mutual fund company to shareholders of a fund must also be done on a bi-lateral basis between the fund and the investor or intermediary. Finally, any other corporate actions, such as share splits or exchanges, must be handled on a bi-lateral basis. This reliance on direct contact between parties results in duplicative records management, and onerous share reconciliation issues.

In addition, and a further complication, most mutual fund companies offer multiple “share classes” for the same fund. That is, for each fund the company establishes, they will offer more than one type of share. While each share class represents equity ownership in precisely the same fund, they differ in how intermediaries (such as B/Ds) are compensated for selling the shares to investors. Each share class is a separate security with its own security identifiers, such as ticker symbol and CUSIP. CUSIP stands for Committee on Uniform Securities Identification Procedures. A CUSIP number identifies most securities, including: stocks of all registered U.S. and Canadian companies, and U.S. government and municipal bonds. The CUSIP system—owned by the American Bankers Association and operated by Standard & Poor's—facilitates the clearing and settlement process of securities. The number consists of nine characters (including letters and numbers) that uniquely identify a company or issuer and the type of security.

The bi-lateral system with multiple share classes for each fund results in several problems, most notably, (1) bilateral settlement between the investor community and the funds is not efficient, and (2) share class tracking and reconciliation management is onerous for all parties.

These problems are illustrated in FIG. 1. Each B/D 131-133 must separately settle with the fund company 101 for multiple classes of shares 120-125 with each mutual fund 110, 111 offered by the fund company 101. Furthermore, each B/D 131, 132, 133 must keep track of multiple classes of shares 120-125 from each mutual fund 110, 111 offered by the fund company 101.

### SUMMARY OF THE INVENTION

The invention solves the aforementioned problems with settlement and recordkeeping for mutual fund transactions by establishing a single, centralized mutual fund settlement and record-keeping platform. The invention adapts current mutual fund order flow processes by leveraging existing mechanisms in the equities markets into a new mutual fund infrastructure to create a centralized and compressed settlement and record-keeping system for mutual funds. The invention creates a new process to separate marketing fees and other expenses from a total mutual fund transaction. This enables the netting of all fund transactions across both those who initiated the transactions and all share classes. This allows the reporting of a true “net” trade to the portfolio manager of a particular fund. The centralized record-keeping will also provide a far more efficient mechanism for making distributions to investors and recording the effect of other corporate actions on investor or intermediary accounts.

The invention includes a method of settling transactions in shares of a mutual fund comprising receiving a first set of data on a central computer system over a secure computer network, said first set of data comprising order information for an order to buy or sell shares of a mutual fund; receiving a second set of data on the central computer system over the secure computer network, said second set of data comprising order information for an order to buy or sell shares of the mutual fund; calculating on the central computer system a net number of shares of the mutual fund to be bought or sold; and sending a third set of data by the central computer system to the mutual fund company, said third set of data comprising the net number of shares of the mutual fund to be bought or sold. In one embodiment, the first set of data is received from a first broker-dealer. In another embodiment, the second set of data is received from a second broker-dealer. In another embodiment, the number of shares held by each shareholder of the mutual fund is maintained by the central computer system. In another embodiment, the first set of data comprises order information for an order to sell shares of a mutual fund, and the central computer system determines whether an account of a seller of shares of the mutual fund contains a sufficient number of shares to sell. In another embodiment, the first set of data comprises order information for an order to buy shares of a mutual fund, and the central computer system determines whether an account of a buyer of shares of the mutual fund contains sufficient funds to purchase the number of shares ordered. In another embodiment, the step of calculating involves matching buy orders and sell orders. In another embodiment, the central computer system keeps records of the identities of the entities who place orders to buy or sell shares of the mutual fund. In another embodiment, the central computer uses a subset of a security identifier in order to identify the mutual fund without regard to a share class of the mutual fund. In another embodiment, the first set of data is received directly from a shareholder. In another embodiment, the first set of data is received from a broker-dealer.

The invention further includes a method of administering shares of a mutual fund comprising receiving on a central computer system information from the mutual fund over a computer network; determining by the central computer system whether to pay dividends based on the information received from the mutual fund; and electronically paying distributions to shareholders of the mutual fund by the central computer system.

The invention further includes a method of administering shares of a mutual fund comprising receiving on a central computer system information from the mutual fund over a computer network; and distributing by the central computer system the information from the mutual fund to shareholders of the mutual fund over a computer network. In one embodiment, the information comprises positions, order confirmations, conversions, transfers, or account level updates.

The invention further includes a method of administering shares of a mutual fund comprising receiving on a central computer system corporate action information from the mutual fund over a computer network; and accounting by the central computer system for the effect of the corporate action information to the number or value of the shares held by shareholders of the mutual fund.

### DESCRIPTION OF THE FIGURES

FIG. 1 is a diagram illustrating the settlement and record-keeping complexity of a prior art mutual fund accounting system.

FIG. 2 is a diagram illustrating a system and method of the invention with a mutual fund central system takes orders directly from shareholders or through broker/dealers.

FIG. 3 is a diagram illustrating the netting process in the mutual fund central.

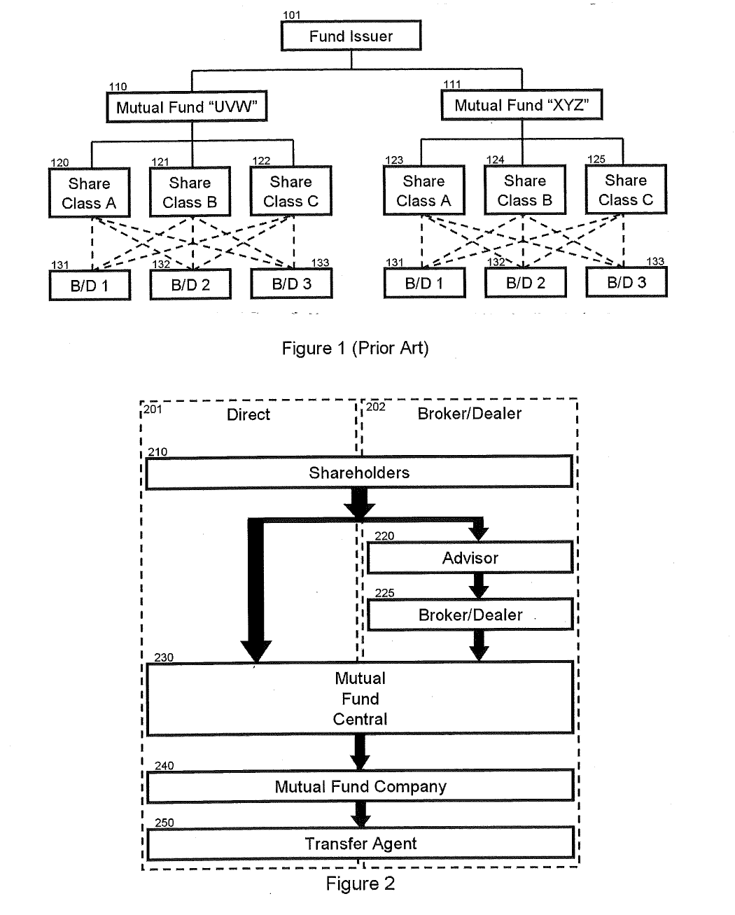

### DETAILED DESCRIPTION

The invention provides a central settlement system and methods for transactions in interests in mutual funds. Before this invention, shareholders could purchase shares from a mutual fund company directly or through a broker/dealer. The invention would allow a structure that appeared to shareholders to be the same, but in fact creates efficiencies in trading and recordkeeping absent in the prior art. FIG. 2 illustrates the general concept. In the direct route 201, shareholders initiate buy or sell transactions by communication with a mutual fund central (“MFC”) repository 230. If they prefer, shareholders may initiate buy or sell transactions through a broker/dealer 225, or may be sold shares by a financial advisor 220 in the broker/dealer path 202. Either way, all transactions pass through the MFC.

Orders may be placed with the MFC, for example, through a computer system over a communications network. Shareholders 210 may use computers to communicate over a communications network with an MFC 230 computer to place buy or sell orders with the MFC 230. Broker/dealers 225 likewise may use computers to place buy or sell orders on behalf of shareholders 210 over a communications network with an MFC computer 230. In one embodiment, the communications network used by broker/dealers 225 to communicate with the MFC is the Secure Financial Transaction Infrastructure, a highly secure and redundant communications network owned by NYSE. The MFC computer may be part of a networked computer system to receive buy and sell orders, to calculate net orders, and to place orders electronically with the mutual fund company 240. The mutual fund company 240 may receive orders electronically by computer over a communications network.

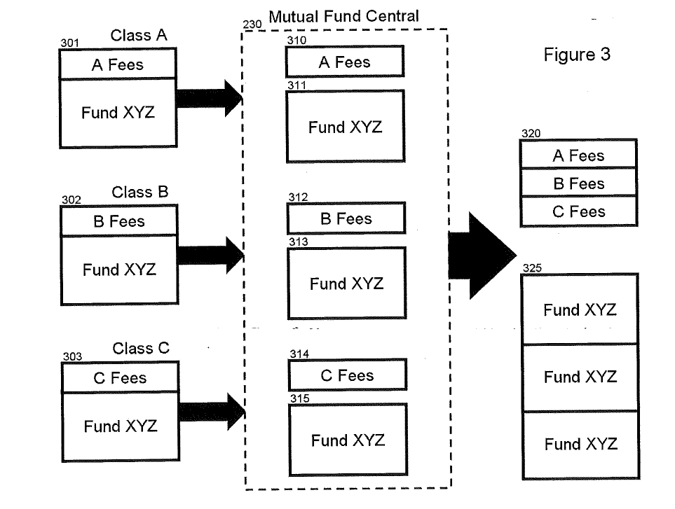

The MFC 230 settles all incoming orders it receives either directly from shareholders 210 or through B/Ds 225. It may maintain the order information through an electronic book-entry system on a computer system. Subscription and redemption of funds are netted across brokers, shareholders, and fund classes by the MFC to yield one net order for a given fund, as shown in FIG. 3 and explained in more detail below. The MFC 230 also maintains an electronic file with non-order related information (“non-order data”) that the mutual fund company is required to keep, including positions, order confirmations, conversions, transfers, account level updates, and other information. The MFC 230 may also maintain profiles of all participating mutual funds on a security master file, an electronic file containing non-order related information regarding the mutual fund such as the fund name, fund security identifier (e.g., CUSIP, ticker symbol), fund company name, information regarding compensation to third parties for selling fund shares, etc. The MFC 230 may also maintain an electronic database of investor account level information to support account level processing functions such as name and address, taxpayer ID, holdings data, and other information.

The net order from the MFC 230 is sent to the mutual fund company 240 along with the non-order data. The transfer agents 250 of the mutual fund companies 240 may receive the net order and non-order data directly, or it may be passed through the mutual fund company 240. The mutual fund transfer agent 250 generates confirmations for all net orders. The MFC 230 may generate confirmations for individual shareholder orders and orders coming through broker dealers 225. The mutual fund company 240 may communicate all other pertinent information regarding the fund, such as dividend distributions, capital changes, and other information, to the MFC 230, which distributes this information to all MFC 230 shareholder 210 and B/D 225 participants.

FIG. 3 illustrates the netting process in the MFC 230. To simplify the netting of a given fund's shares across classes and brokers, MFC 230 may separate the underlying fund investment 311, 313, 315 of each order 301-303 from their marketing fees 310, 312, 314. This netting will be accomplished by an MFC computer using the following steps:

1. The CUSIP (fund security identifier) for each transaction submitted to the MFC computer will be utilized to identify the specific fund and fund share class. The computer will use all 9 digits of the CUSIP for this task.

2. Utilizing information contained in the security master file, the MFC computer will determine the amounts of the total transaction that are to be used for compensating the intermediary and the amounts to be deposited or withdrawn from the fund investments.

3. The MFC computer will then aggregate across all share classes of the same fund only the amounts to be deposited or withdrawn from the fund investments. The computer will do this by adding together the relevant amounts for all shares which have the same first 6 characters of their CUSIP. Every share class of the same fund will have the same unique 6 characters as the beginning of its CUSIP. These aggregated amounts will be the net amounts to be deposited or withdrawn from the fund investments, irrespective of the share class.

One aggregate trade 325 may then be sent to the mutual fund company 240, allowing for efficient processing of multiple complex transaction records in order to distill fund transactions to net share orders only. The netting process may be performed by the MFC 230 on a MFC computer system.

In another embodiment, all net trades between funds and investors or B/Ds will be guaranteed through the establishment of a clearing facility within MFC. This facility would consist of mutual fund companies and B/Ds becoming members of the facility and contributing capital to act as guarantee funds to be used is the event of the default on a transaction(s) by one of the other members. All trades would be processed by MFC, for example by electronic processing on a computer with electronic storage media including a database for storing information on the trades. The trades then become obligations of the clearing facility through the process of novation, wherein the original counterparty to each transaction is replaced by the clearing facility. Thus, the clearing facility, and its members, become the guarantors to each transaction.

I claim:

1) A method of settling transactions in shares of a mutual fund comprising:
receiving a first set of data on a central computer system over a secure computer network, said first set of data comprising order information for an order to buy or sell shares of a mutual fund;
receiving a second set of data on the central computer, system over the secure computer network, said second set of data comprising order information for an order to buy or sell shares of the mutual fund;
calculating on the central computer system a net number of shares of the mutual fund to be bought or sold; and
sending a third set of data by the central computer system to the mutual fund company, said third set of data comprising the net number of shares of the mutual fund to be bought or sold.

2) The method of claim 1, wherein the first set of data is received from a first broker-dealer.

3) The method of claim 2, wherein the second set of data is received from a second broker-dealer.

4) The method of claim 1, wherein the number of shares held by each shareholder of the mutual fund is maintained by the central computer system.

5) The method of claim 1, wherein the first set of data comprises order information for an order to sell shares of a mutual fund, and the central computer system determines whether an account of a seller of shares of the mutual fund contains a sufficient number of shares to sell.

6) The method of claim 1, wherein the first set of data comprises order information for an order to buy shares of a mutual fund, and the central computer system determines whether an account of a buyer of shares of the mutual fund contains sufficient funds to purchase the number of shares ordered.

7) The method of claim 1, wherein the step of calculating involves matching buy orders and sell orders.

8) The method of claim 1, wherein the central computer system keeps records of the identities of the entities who place orders to buy or sell shares of the mutual fund.

9) The method of claim 1, wherein the central computer uses a subset of a security identifier in order to identify the mutual fund without regard to a share class of the mutual fund.

10) The method of claim 1, wherein the first set of data is received directly from a shareholder.

11) The method of claim 1, wherein the first set of data is received from a broker-dealer.

12) A method of administering shares of a mutual fund comprising:
receiving on a central computer system information from the mutual fund over a computer network;
determining by the central computer system whether to pay dividends based on the information received from the mutual fund; and
electronically paying distributions to shareholders of the mutual fund by the central computer system.

13) A method of administering shares of a mutual fund comprising:
receiving on a central computer system information from the mutual fund over a computer network; and
distributing by the central computer system the information from the mutual fund to shareholders of the mutual fund over a computer network.

14) The method of claim 13, wherein the information comprises positions, order confirmations, conversions, transfers, or account level updates.

15) A method of administering shares of a mutual fund comprising:
receiving on a central computer system corporate action information from the mutual fund over a computer network; and
accounting by the central computer system for the effect of the corporate action information to the number or value of the shares held by shareholders of the mutual fund.
